(19) United States
(12) Patent Application Publication
(10) Pub. No.: US 2014/0224005 A1
(43) Pub. Date: Aug. 14, 2014

(54) VEHICLE INSPECTION TOOL

(71) Applicant: Poul Chang Metal Industry Co., Ltd., (US)

(72) Inventor: CHIA-HAO HUANG, Taichung City (TW)

(73) Assignee: POUL CHANG METAL INDUSTRY CO., LTD., Taichung City (TW)

(21) Appl. No.: 13/763,138

(22) Filed: Feb. 8, 2013

(51) Int. Cl. G01M 17/04

(52) U.S. Cl. CPC G01M 17/04
USPC 73/117.03

(57) ABSTRACT

A vehicle inspection tool includes a tool body having an outer surface fitting the tread of the tire of a vehicle wheel, and a spanner adapter fixedly mounted each of two opposite ends of the tool body and defining therein a coupling hole for receiving a L-shaped spanner for enabling the tool body to be biased by the L-shaped spanner to oscillate the wheel and its suspension system so that the user can detect any abnormalities of the component parts of the suspension system subject to generated noises, achieving quick inspection.

### BACKGROUND OF THE INVENTION

1. Field of the Invention

The present invention relates to inspection tools and more particularly to a vehicle inspection tool that can be used with an L-shaped spanner to inspect a vehicle wheel with a suspension system, discovering abnormalities of component parts of the suspension system.

2. Description of the Related Art

A car suspension system is a connection structure between the car body/car frame and the wheel for absorbing shocks and impact when the car is running over an uneven road surface. This impact will be partially absorbed by the tire of the wheel and majorly absorbed by the suspension system. Except the functions of supporting the car body and absorbing shocks and impact, the suspension system can also keep the tire in positive contact with the road surface, enhancing tire grip, car handling and driving safety, keeping maximum passenger comfort, avoiding damage to the car component parts due to huge shock, and protecting luggage cargo.

Referring to FIG. 1, the arrangement of a suspension system and a front wheel of a vehicle is shown. As illustrated, the suspension system 100 comprises at least a transmission shaft 102 for rotating the tire 101, a shock absorber 103, an upper arm 104 connected to the upper arm 104, and a lower arm 105 connected to the upper arm 104. When a car is sent to a garage for maintenance and repair, the technician will use different tools, subject to his own experience, to lift or pull components parts of the suspension system, or make a real road test, inspecting any abnormality or damage of every component part and making sure of normal functioning of the suspension system.

However, there is no any inspection tool specifically designed for technicians to inspect a vehicle suspension system. Inspecting a vehicle suspension system is difficult and takes much time. The use of conventional inspection tools cannot rapidly discover any abnormalities to eliminate driving related injury risk.

### SUMMARY OF THE INVENTION

The present invention has been accomplished under the circumstances in view. It is the main object of the present invention to provide a vehicle inspection tool, which is operable by an L-shaped spanner to oscillate the tire of a vehicle wheel and its suspension system for quick inspection of abnormalities of component parts of the suspension system.

To achieve this and other objects of the present invention, a vehicle inspection tool comprises a tool body comprising opposing first end and second end, an axis line extending between the first end and the second end and an outer surface surrounding the axis line, and a spanner adapter located at each of the opposing first and second ends of the tool body and defining therein a coupling hole for the connection of a driving end of a L-shaped spanner that is readily available in the garage. Thus, the tool body can be biased by the attached L-shaped spanner to oscillate the wheel and its suspension system so that the user can detect any abnormalities of the component parts of the suspension system subject to generated noises and discover the locations of abnormalities and then take the necessary measures at the first time point to eliminate abnormalities at the first time point, reducing driver risk.

Preferably, each spanner adapter can be fixedly fastened to the first end or second end of the tool body by welding.

Preferably, each spanner adapter comprises an embossed pattern on the outer surface thereof. Further, the tool body defines therein an accommodation chamber extending between the opposing first end and second end. Further, each spanner adapter can be tightly press-fitted into one of the opposing first and second ends of the tool body, or alternatively, each spanner adapter can be made having a non-circular outer surface fitting the non-circular cross section of the accommodation chamber of the tool body.

### BRIEF DESCRIPTION OF THE DRAWINGS

FIG. 1 is a schematic drawing illustrating a suspension system arranged at a front wheel of a car.

FIG. 2 is an elevational view of a vehicle inspection tool in accordance with the present invention.

FIG. 3 is an exploded view of the vehicle inspection tool in accordance with the present invention.

FIG. 4 is a schematic sectional view, in an enlarged scale, of a part of the vehicle inspection tool in accordance with the present invention.

FIG. 5 illustrates an application example of the vehicle inspection tool in accordance with the present invention (I).

FIG. 6 illustrates an application example of the vehicle inspection tool in accordance with the present invention (II).

FIG. 7 illustrates an application example of the vehicle inspection tool in accordance with the present invention (III).

FIG. 8 is a schematic perspective exploded view of an alternate form of the vehicle inspection tool in accordance with the present invention, illustrating the spanner adapters peripherally embossed.

FIG. 9 is a schematic cross-sectional view of another alternate form of the vehicle inspection tool in accordance with the present invention, illustrating non-circular fitness between the tool body and the spanner adapter.

### DETAILED DESCRIPTION OF THE INVENTION

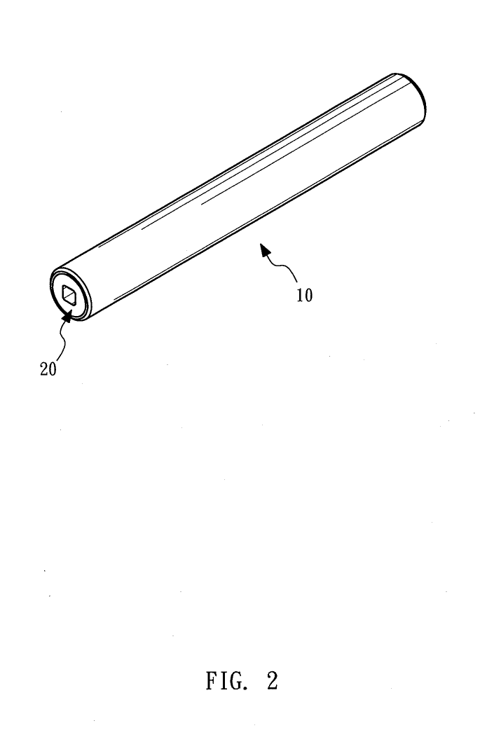

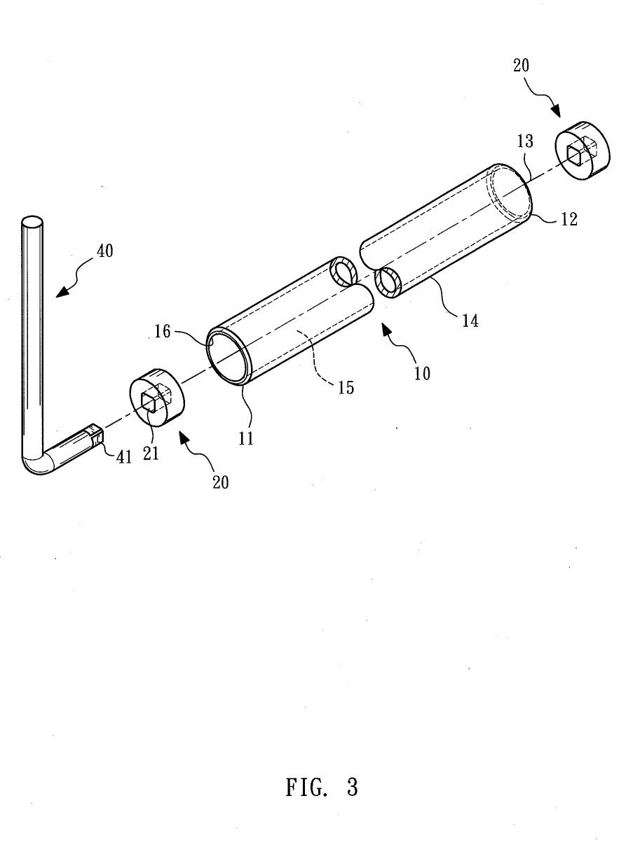

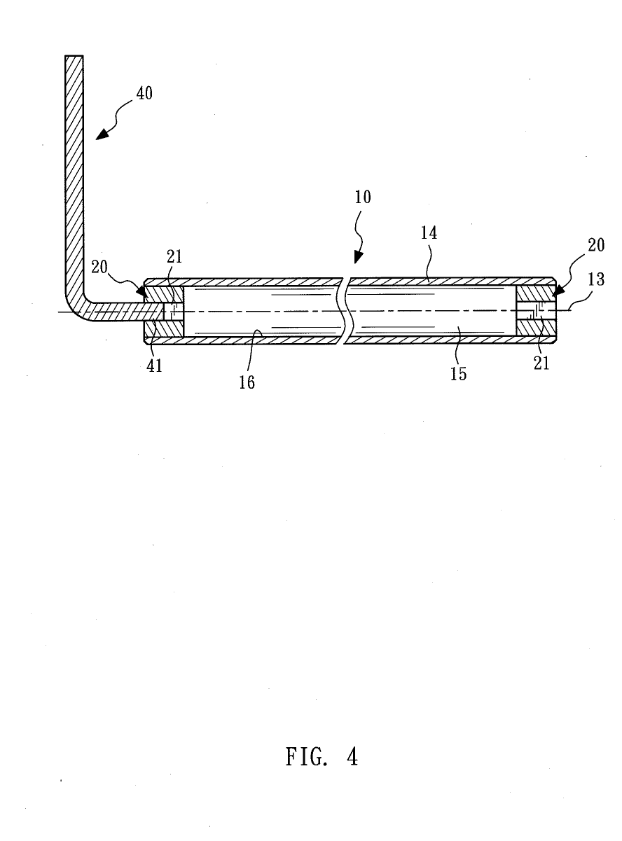

Referring to FIGS. 2-4, a vehicle inspection tool in accordance with the present invention is shown. The vehicle inspection tool comprises a tool body 10 and two spanner adapters 20.

The tool body 10 comprises opposing first end 11 and second end 12, an axis line 13 extending between the first end 11 and the second end 12, and an outer surface 14 surrounding the axis line 13 and fitting the tread of the tire of a vehicle wheel. The outer surface 14 is a surface of full circle. The tool body 10 can be a round tube, defining therein an inner circumference 16 and an accommodation chamber 15 surrounded by the inner circumference 16. Further, the outer surface 14 is a smooth surface, facilitating the operation of the tool body 10.

The spanner adapters 20 are mounted in the accommodation chamber 15 of the tool body 10 and respectively disposed at the first end 11 and the second end 12. Each spanner adapter 20 defines a coupling hole 21 that extends along the direction of the axis line 13 of the tool body 10. The coupling hole 21 is a polygonal hole adapted to receive a driving end 41 of an L-shaped spanner 40, enabling the tool body 10 to be driven to rotate by the L-shaped spanner 40 in the axis line 13. The spanner adapters 20 are welded to the tool body 10 to prevent rotation relative to the tool body 10. Affixing these two spanner adapters 20 to the opposing first end 11 and second end 12 of the tool body 10 enables the vehicle inspection tool to provide an operating end at each of the two opposite ends thereof. However, this arrangement is not a limitation.

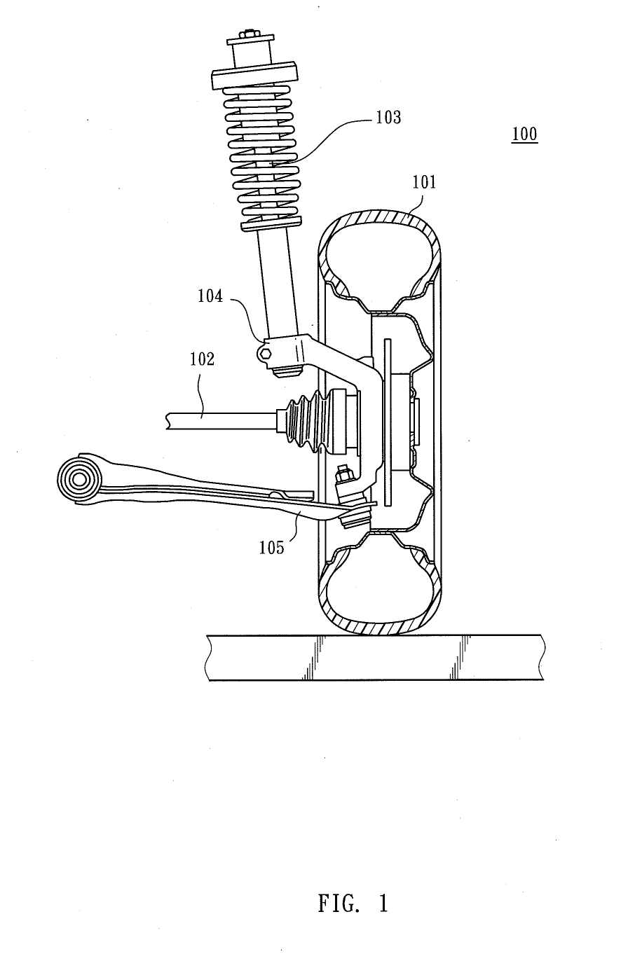

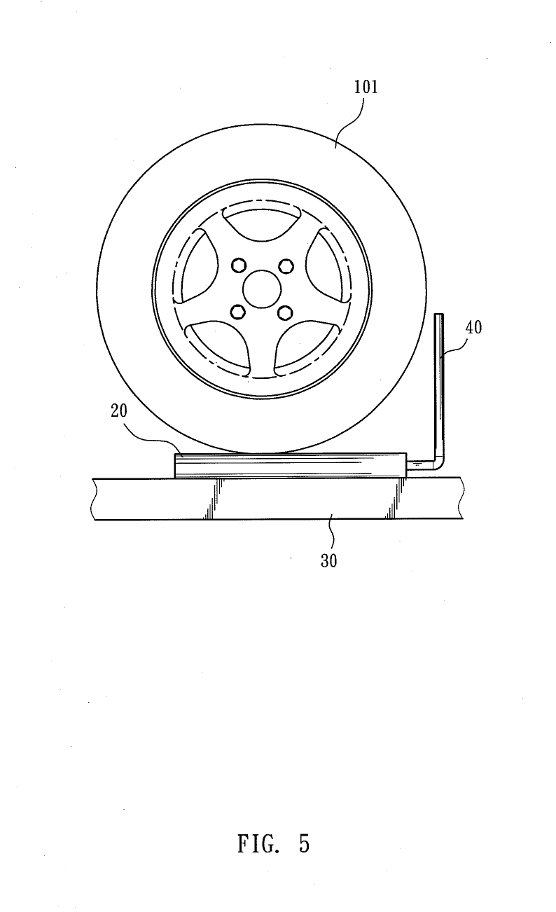

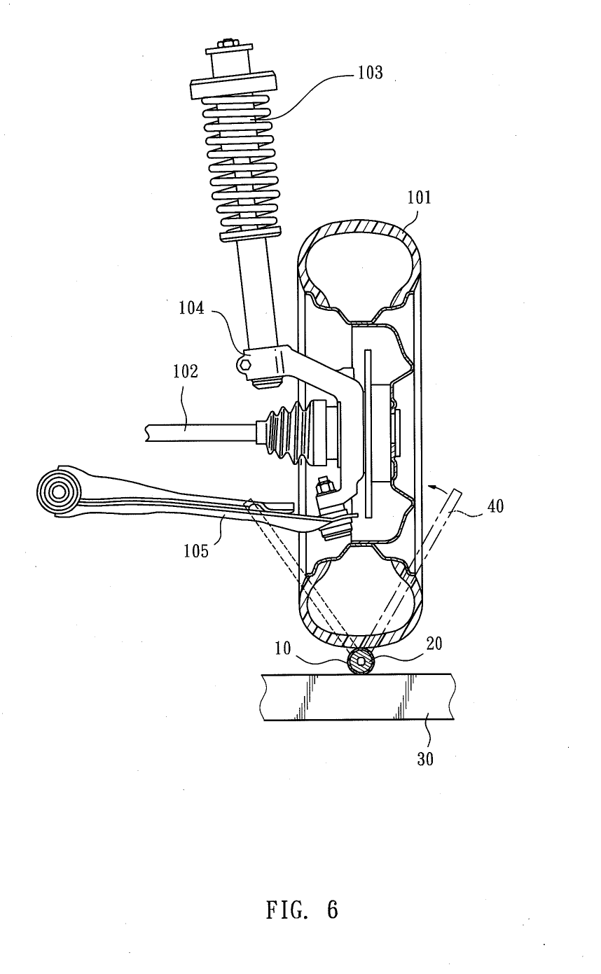

Referring to FIGS. 5 and 6, the vehicle inspection tool is suitable for inspecting the tire 101 of a vehicle wheel that is equipped with a suspension system 100. This suspension system 100, as shown in FIG. 1, is known prior art device, and therefore no further detailed description on the structure of this suspension system shall be given. When the tool body 10 is set between the work table 30 and the tire 101 during inspection, the axis line 13 of the tool body 10 is kept in the running direction of the tire 101, and at the same time, the outer surface 14 of the tool body 10 is abutted against the tread of the tire 101. At this time, the user can attach the driving end 41 of the L-shaped spanner 40 to the coupling hole 21 of the spanner adapter 20 at one end of the tool body 10 and then turn the L-shaped spanner 40 back and forth about the axis line 13 of the tool body 10, forcing the tire 101 and the suspension system 100 to oscillate, and thus the user can detect any abnormalities of the component parts of the suspension system 100 subject to generated noises and discover the locations of abnormalities. Thus, the user can rapidly inspect any abnormalities and failure of the suspension system 100 and rule out the troubles at the first time point, reducing driver risk.

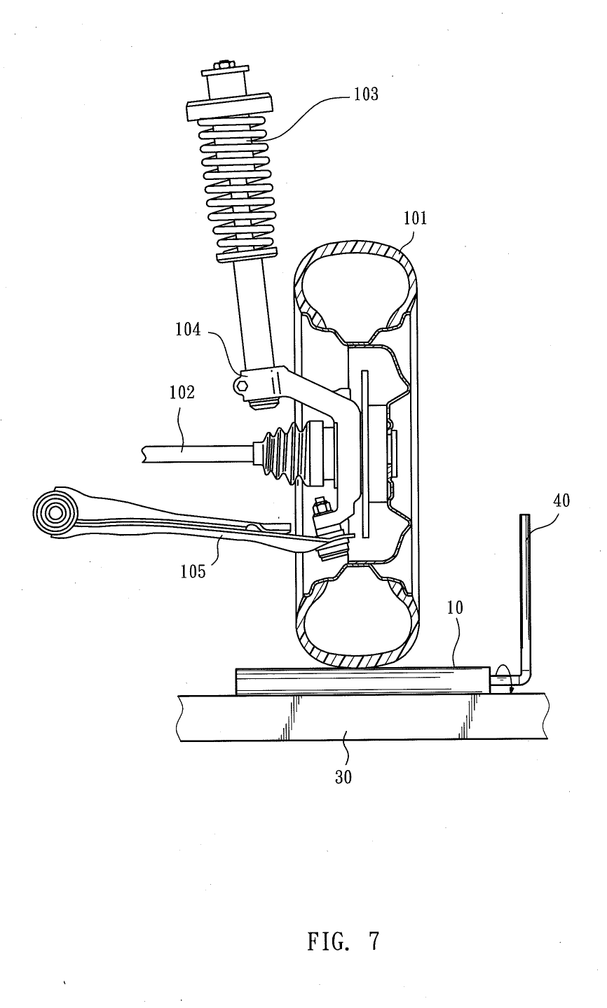

FIG. 7 illustrates another application example of the vehicle inspection tool in accordance with the present invention. As illustrated, the tool body 10 is transversely set between the tire 101 and the work table 30 to keep the axis line 13 in parallel to the lower arm 105. At this time, the user can operate the L-shaped spanner 40 to bias the tool body 10, forcing the tire 101 and the suspension system 100 to oscillate in a direction different from that shown in FIG. 5, and thus the user can discover any abnormality of the component parts of the suspension system 100 and estimate the locations of abnormalities, and then take the necessary steps to eliminate the abnormalities.

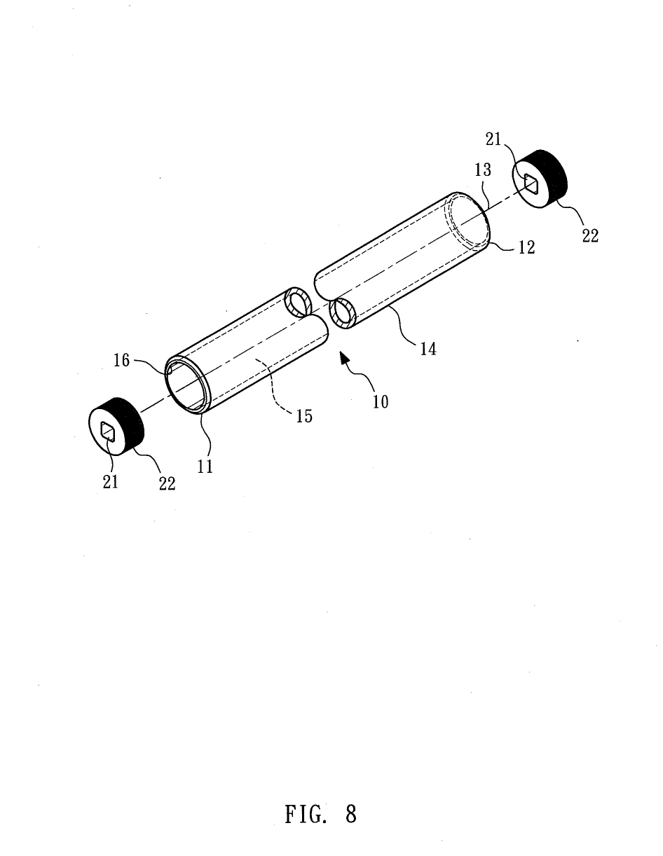

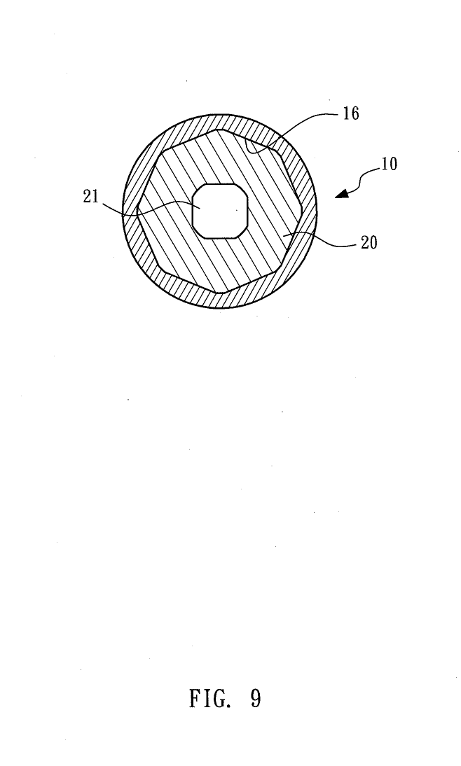

FIG. 8 and FIG. 9 illustrate two different alternate forms of the vehicle inspection tool in accordance with the present invention. According to the embodiment shown in FIG. 8, each spanner adapter 20 comprises an embossed pattern 22 located at the outer surface thereof to enhance friction relative to the first end 11 or second end 12 in the accommodation chamber 15 of the tool body 10, avoiding rotation between the spanner adapters 20 and the tool body 10. According to the embodiment shown in FIG. 9, the outer surface of each spanner adapter 20 is not circular; the cross section of the accommodation chamber 15 of the tool body 10 is not circular and fits the contour of the spanner adapters 20, and thus, the spanner adapters 20 can be respectively and tightly press-fitted into the first end 11 and the second end 12 in the accommodation chamber 15 of the tool body 10 and prohibited from rotation relative to the tool body 10.

In conclusion, the invention provides a vehicle inspection tool, which comprises a tool body and a spanner adapter located at each of two opposite ends of the tool body for the connection of a L-shaped spanner that is readily available in the garage, enabling the tool body to be biased by the L-shaped spanner to oscillate the wheel and its suspension system so that the user can detect any abnormalities of the component parts of the suspension system subject to generated noises and discover the locations of abnormalities and then take the necessary measures to eliminate abnormalities at the first time point, reducing driver risk. Further, the vehicle inspection tool has the advantages of simple structure and ease of operation. Subject to the use of the vehicle inspection tool, a professional technician can greatly shorten the inspection time.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A vehicle inspection tool, comprising:
a tool body comprising a first end, a second end opposite to said first end, an axis line extending between said first end and said second end, and an outer surface surrounding said axis line and fitting the tread of the tire of a vehicle wheel; and
at least one spanner adapter mounted at at least one of said first end and said second end of said tool body and prohibited from rotation relative to said tool body, each said spanner adapter comprising a coupling hole extending in the direction of said axis line for receiving a driving end of a L-shaped spanner for rotating said tool body.

2. The vehicle inspection tool as claimed in claim 1, wherein said tool body is a round tube.

3. The vehicle inspection tool as claimed in claim 1, wherein said outer surface of said tool body is a smooth surface.

4. The vehicle inspection tool as claimed in claim 1, wherein said outer surface of said tool body is surface of full circle.

5. The vehicle inspection tool as claimed in claim 1, wherein the number of said at least one spanner adapter is 2, and the two spanner adapters are respectively mounted at the first end and second end of said tool body.

6. The vehicle inspection tool as claimed in claim 1, wherein said tool body defines therein an accommodation chamber extending along said axis line between said first end and said second end; each said spanner adapter has an outer surface fitting said accommodation chamber.

7. The vehicle inspection tool as claimed in claim 1, wherein each said spanner adapter is fixedly fastened to one of said first end and said second end of said tool body by welding.

8. The vehicle inspection tool as claimed in claim 6, wherein each said spanner adapter comprises an embossed pattern on an outer surface thereof.

9. The vehicle inspection tool as claimed in claim 6, wherein said accommodation chamber has a non-circular cross section; the outer surface of each said spanner adapter has is non-circular and fits the non-circular cross section of said accommodation chamber.
